(19) United States
(12) Patent Application Publication
(10) Pub. No.: US 2012/0306219 A1
(43) Pub. Date: Dec. 6, 2012

(54) COVER LOCKING MECHANISM

(75) Inventors: Akiyo Takada, Chiyoda-ku (JP); Yasuaki Mamoto, Chiyoda-ku (JP)

(73) Assignee: MITSUBISHI ELECTRIC CORPORATION, TOKYO (JP)

(21) Appl. No.: 13/578,748

(22) PCT Filed: Feb. 16, 2010
(86) PCT No.: PCT/JP2010/052276

§ 371 Date: Aug. 13, 2012

(51) Int. Cl. E05C 19/12

(52) U.S. Cl. 292/121

(57) ABSTRACT

A cover locking mechanism is provided to a cover hinged to an opening portion of a casing to be openable/closable and has a latch formed hookable on to a circumference of the opening portion of the casing. It includes a plate spring, one end of which (one end of the plate spring) is attached to the cover, and which provides a biasing force in a direction from an inner side of the cover toward the circumference to the latch thereby to bias the latch attached to the other end (other end of the spring) toward the circumference and to bring the latch into contact with the circumference. The latch has a configuration (first notch) for holding the cover at a first angle and a configuration (second notch) for preventing the cover from being opened beyond a second angle greater than the first angle, during cover opening operation.

### FIELD

The present invention relates to a locking mechanism of a cover attached via a hinge to a main body of a casing that accommodates electronic devices and the like.

### BACKGROUND

Vehicles such as a train and an automobile are equipped with various electronic devices and pneumatic or hydraulic control devices. These various control devices are placed inside, under a floor, or on a roof of the vehicle, and in most cases placed in a casing having a cover for keeping out wind, rain, snow, dust and the like because these devices are quite important to ensure safety of the vehicle.

A typical casing is provided with an open/close cover in its casing opening, that turns with a hinge, and when a handle provided on the cover is turned at a predetermined angle, a stop provided at an opposite end of the handle is engaged with the casing opening portion, thereby preventing the cover from being opened accidentally. However, there has been a problem that the cover may be opened because of vibrations caused during running of the vehicle if a maintenance worker forgets to lock or insufficiently locks the cover after finishing maintenance and inspection of the devices inside in the casing.

As means for solving this problem, a conventional cover locking mechanism described in Patent Literature mentioned below has a latch one end of which is held by a plate spring mounted on a back face of a cover and the other end of which is hook-shaped. This hook is engaged with an opening portion due to a biasing force of the plate spring, whereby the cover is prevented from being opened beyond a predetermined angle even if the cover is left unlocked.

### CITATION LIST

### Patent Literature

Patent Literature 1: International Publication No. WO2006/006210

### SUMMARY

### Technical Problem

The conventional technique described in Patent Literature mentioned above, however, has a problem that when the vibrations caused during vehicle running are significantly large, the hook may be disengaged therefrom and sometimes a function as the cover locking mechanism is not fulfilled. There is also a problem that when the cover is pulled frontward hard during maintenance and inspection, the hook may be deformed or broken and the function as the cover locking mechanism may be deteriorated or lost.

The present invention has been achieved in view of the above-mentioned circumstances, and an object of the present invention is to provide a cover locking mechanism that can prevent its function from deteriorating.

### Solution to Problem

In order to solve the above-mentioned problems and achieve the object, the present invention provides a cover locking mechanism that is provided to a cover hinged to an opening portion of a casing to be openable/closable by a hinge and has a latch formed to be hookable on to a circumference of the opening portion of the casing, the cover locking mechanism comprising: a plate spring, one end of which is attached to the cover, and which provides a biasing force in a direction from an inner side of the cover toward the circumference of the opening portion thereby to bias the latch attached to the other end of the spring toward the circumference of the opening portion and to bring the latch into contact with the circumference of the opening portion, wherein the latch has a configuration for holding the cover at a first open angle and a configuration for preventing the cover from being opened beyond a second open angle that is greater than the first open angle, during an opening operation of the cover.

### Advantageous Effects of Invention

According to the present invention, a latch is provided which has a hook engaged with the opening portion of the casing at an arbitrary position thereof by a biasing force of the plate spring attached to the inside of the cover, and a notch fitted to an end of the opening portion of the casing. Therefore, function deterioration can be restricted.

### BRIEF DESCRIPTION OF DRAWINGS

FIG. 1 is an external view of a casing and a cover.

FIG. 2 is a rear view of the cover shown in FIG. 1.

FIG. 3 is an explanatory diagram of a state where a stop shown in FIG. 2 is stuck on an opening portion.

FIG. 4 is an explanatory diagram of a state where a latch shown in FIG. 2 is hooked on to the opening portion.

FIG. 5 is an illustration showing details of a cover locking mechanism according to a first embodiment of the present invention.

FIG. 6 is an explanatory diagram of operations when the cover is closed.

FIG. 7 is an explanatory diagram of operations when a hook is fitted to a protrusion.

FIG. 8 is an explanatory diagram of operations when the cover is opened.

FIG. 9 is an illustration showing a latch with omission of a first notch.

FIG. 10 is an illustration showing a cover locking mechanism according to a second embodiment of the present invention.

### DESCRIPTION OF EMBODIMENTS

Embodiments of a cover locking mechanism according to the present invention will be described below in detail with reference to the drawings. Note that the present invention is not limited to the embodiments.

### First Embodiment

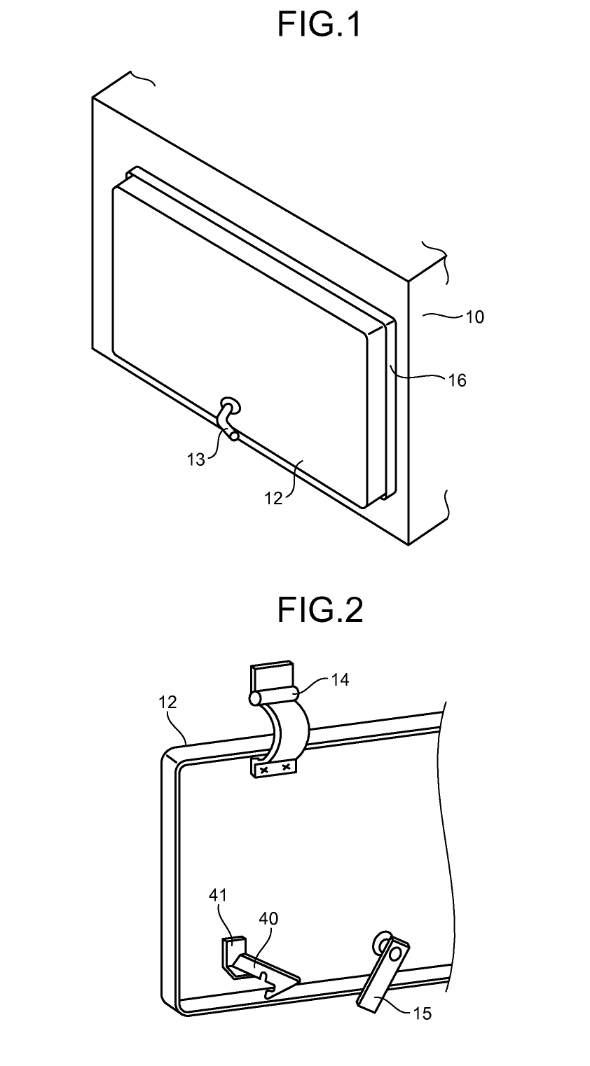

FIG. 1 is an external view of a casing and a cover,

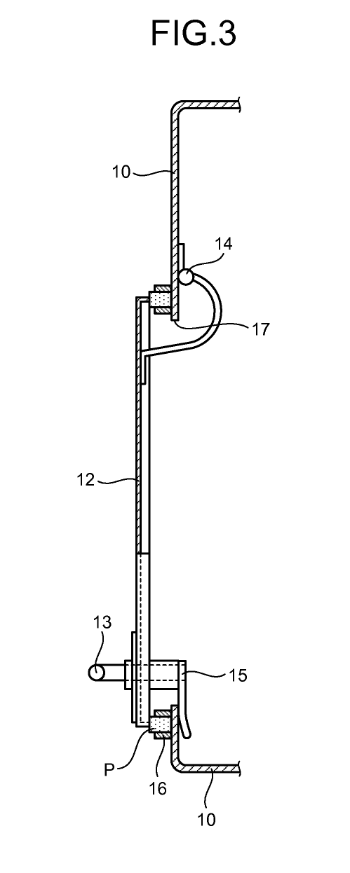

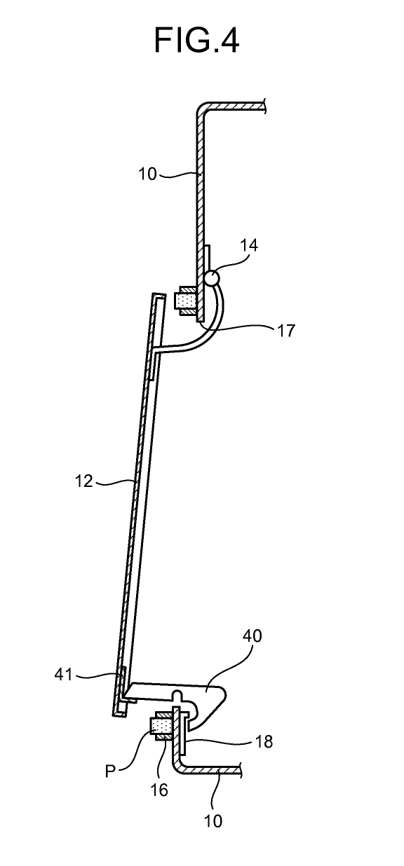

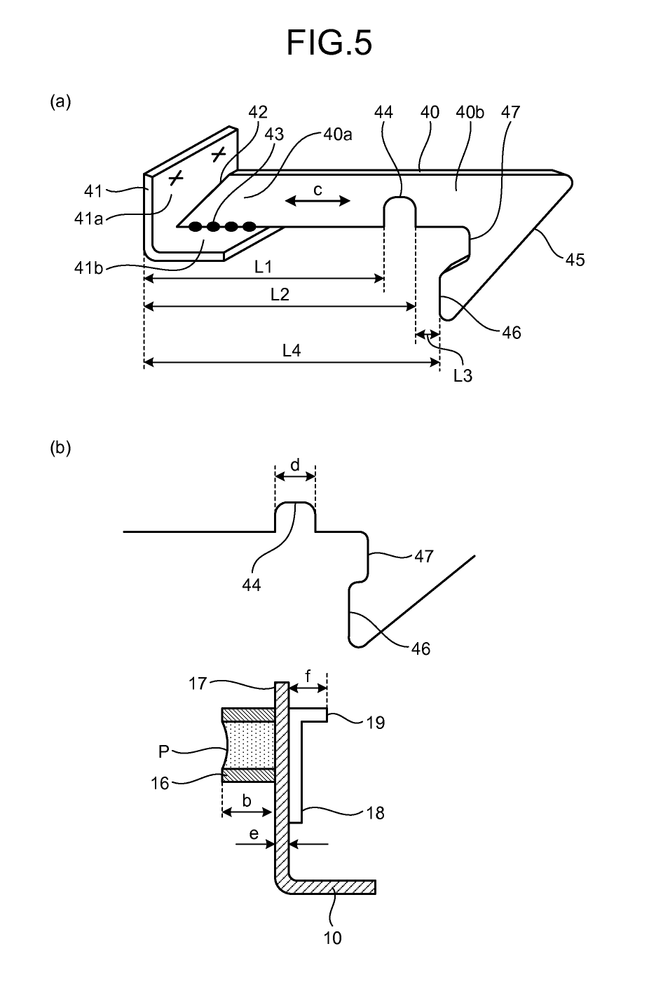

FIG. 2 is a rear view of the cover shown in FIG. 1, FIG. 3 is an explanatory diagram of a state where a stop shown in FIG. 2 is stuck on an opening portion, FIG. 4 is an explanatory diagram of a state where a latch shown in FIG. 2 is hooked on to the opening portion, and FIG. 5 is an illustration showing details of a cover locking mechanism according to a first embodiment of the present invention.

In a casing 10 shown in FIG. 1, a control device and the like are mounted, and a cover 12 is provided to an opening of the casing 10. In FIG. 2, a cover locking mechanism according to the present embodiment is provided on a back face of the cover 12 and includes a plate spring 41 and a latch 40. As long as the cover locking mechanism according to the present embodiment is applied to a box-shaped structure having a door-type cover that performs open/close of the casing 10, there is no limitation to the control devices to be accommodated in the casing 10, and the cover locking mechanism can be used regardless of an opening/closing direction of the cover.

In FIGS. 2 and 3, the cover 12 is provided in such a manner that the opening of the casing 10 can be opened/closed by a hinge 14. A circumference of the cover 12 is bent toward the casing 10. A circumference 17 of the opening portion is provided with a packing gland 16 and a packing P placed inside the packing gland 16. For checking, the cover 12 is turned to the outside of the casing 10 using the hinge 14 as a supporting point, and when the checking is completed, an end of the cover 12 is brought into contact with the packing P. When a handle 13 is turned at a predetermined angle after the cover 12 is closed, a stop 15 is stuck on the inner side of the circumference 17 of the opening portion, so that the end of the cover 12 is pressed against the packing P, thereby improving the dust proofing property and water proofing property.

In FIG. 4, when the handle 13 is incompletely locked, the latch 40 is hooked onto the casing 10, so that the cover 12 is not opened beyond the predetermined angle. In FIGS. 2 and 3, the position of the hinge 14 is an upper side of the cover 12; however, it is not limited thereto and can be any of upper, lower, right and left sides of the cover 12.

FIG. 5 is an illustration showing details of the cover locking mechanism according to the first embodiment of the present invention. FIG. 5(a) depicts the plate spring 41 and the latch 40. One end 41a of the plate spring is provided on the cover 12 by welding or the like, and the other end 41b of the plate spring is connected to one end 40a of the latch by welded portions 43.

For the end 40a of the latch, a back clearance 42 is provided. The back clearance 42 is made by processing to prevent the latch 40 from interfering with the cover 12 when the latch 40 is moved. The other end 40b of the latch is formed with an inclined portion 45, a hook (hook face) 46, a first notch 44 formed into a recess, and a second notch 47 formed into a recess. The inclined portion 45 is beak-shaped so that it interferes with the packing gland 16 or the circumference 17 of the opening portion in the event of closing operation of the cover 12 to cause the latch 40 to move toward a center of the opening.

The latch 40 formed as described above is biased toward the circumference 17 of the opening portion by the plate spring 41, and can move up/down due to elastic deformation of the plate spring 41. That is, the latch 40 is configured in such a manner that the hook 46 can be grappled and held at any position on the circumference 17 of the opening portion by a biasing force of the plate spring 41.

Said “up/down” in this case is explained in more detail. FIG. 1 is an example in which the latch 40 is mounted on a lower part of the cover 12, and therefore a movement direction of the latch 40 is an up/down direction. On the other hand, for example, when the hinge 14 is provided on the left side and the cover 12 is opened to the left, movement of the latch 40 is in a “right/left” direction. That is, by way of generalization, the latch 40 moves in a direction of a line connecting the center of the cover 12 and the circumference 17 of the opening portion.

The first notch 44 is formed at a predetermined distance from the end 41a of the plate spring. On a side closer to the other end 40b of the latch than the first notch 44, the second notch 47 is formed which is cut in a direction substantially orthogonal to the first notch 44.

Dimensions and configurations of portions of the latch 40 shown in FIG. 5 are described below.

Reference sign b shown in FIG. 5(b) denotes the height of the packing gland 16, c denotes a length about 3 to 7 centimeters, which is necessary to push up the latch 40 against a lower face of the latch 40, d denotes a groove width of the first notch 44, e denotes a plate thickness of the casing 10, and f denotes the height of a protrusion 19. The groove width d is slightly larger than the plate thickness of the circumference 17 of the opening portion.

The depth of the groove of the first notch 44 shown in FIG. 5(a) is enough to be larger than a height from the end of the circumference 17 of the opening portion to the packing gland 16 shown in FIG. 5(b), which is about several millimeters. The second notch 47 is formed in such a manner that the protrusion 19 provided on an inner side of the casing 10 is fitted into the second notch 47.

Reference sign L1 shown in FIG. 5(a) is equal to b+c, L2 is L1+d, L3(L) is a length from the hook 46 to the first notch 44, and L4 is L2+L3.

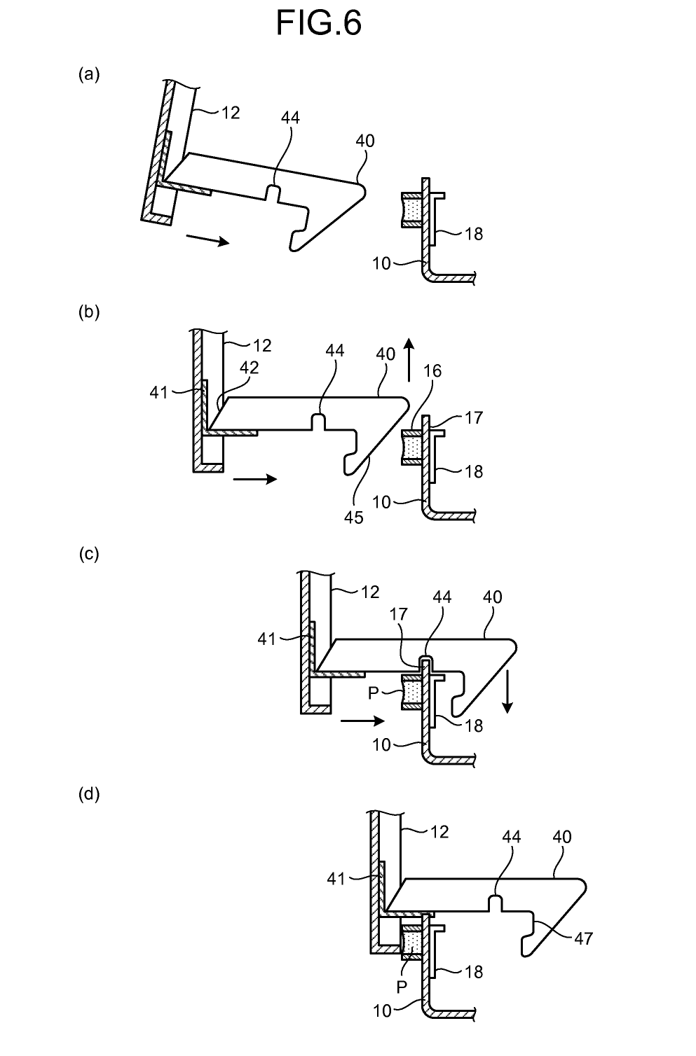

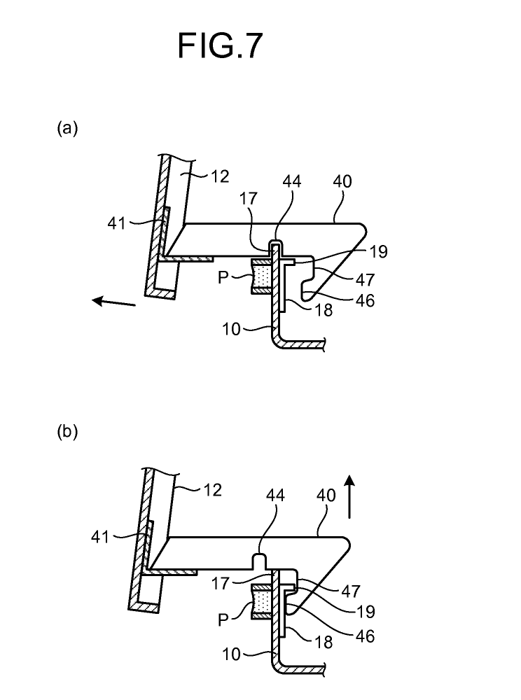

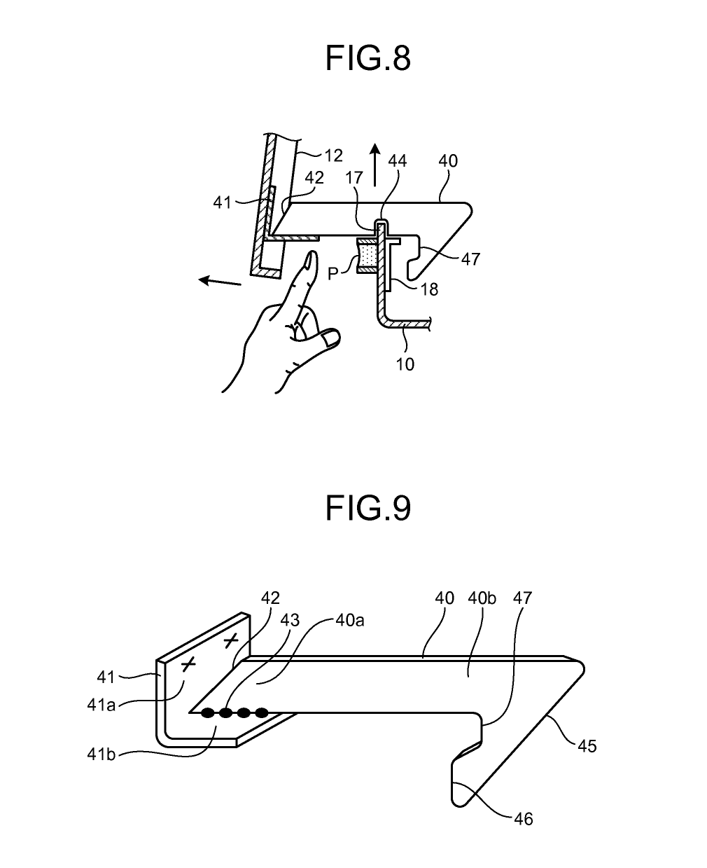

An operation of the latch 40 is explained next. FIG. 6 is an explanatory diagram of operations when the cover is closed, FIG. 7 is an explanatory diagram of operations when the hook is fitted to the protrusion, and FIG. 8 is an explanatory diagram of operations when the cover is opened.

Operations performed when the cover 12 is closed are described In FIG. 6(a), when the cover 12 is pressed in the closing direction, the inclined portion 45 of the latch 40 interferes with the packing gland 16 or the circumference 17 of the opening portion as shown in FIG. 6(b). When interference of the inclined portion 45 occurs, the latch 40 is lifted against a reaction force of the plate spring 41 and slides on an upper face of the packing gland 16. When the latch 40 slides into the inside of the casing 10, the first notch 44 is fitted to the circumference 17 of the opening portion as shown in FIG. 6(c). In this state, the cover 12 is not closed yet. Therefore, a lower face of the latch 40 is pushed up and then the cover 12 is pushed in the closing direction, thereby causing the latch 40 to be inserted into the inside of the casing 10. In consequence, as shown in FIG. 6(d), a circumferential bent portion of the cover 12 interferes with the packing P. Locking is achieved in this state and accordingly the cover 12 is held fixedly.

Operations performed when the cover 12 unlocks (or is unlocked intentionally) and then the cover 12 is opened (opening operations) are explained next. The cover 12 shown in FIG. 7(a) is in a state where the cover 12 is opened outward from the state shown in FIG. 6(d). When the cover 12 starts opening in a direction indicated by an arrow, the first notch 44 is fitted to the circumference 17 of the opening portion. Accordingly, the cover 12 is almost fixed at a position of the first notch 44, and therefore neither opens beyond the length L2 shown in FIG. 5 nor closes under this length.

In other words, the cover 12 is held at a predetermined angle (a first open angle) as shown in FIG. 7(a). For example, for the casing 10 placed under the vehicle floor or the like, the cover 12 solid enough to ensure resistance to stone chips or the like is used. Furthermore, as explained in the above problems, when the hinge 14 is placed on the upper side, a worker needs to locate the latch 40 while lifting the cover. For this reason, the worker needs to grasp a position of the latch 40 while keeping the state of the cover 12 slightly opened, and particularly when a plurality of latches 40 are provided, burdens imposed on the worker increase. According to the cover locking mechanism of the present embodiment, the cover 12 is kept opened, and therefore the worker can easily grasp a position or the like of the latch 40, so that checking operations can be efficiently performed. As described above, the first notch 44 has a configuration for holding the cover 12 at the first open angle.

FIG. 7(b) depicts a state where a strong force is exerted in the opening direction of the cover 12 in the state shown in FIG. 7(a) and thus the circumference 17 of the opening portion is brought away from the first notch 44. In this case, the protrusion 19 provided on an inner side of the casing 10 is fitted into the second notch 47. For example, if neither the second notch 47 nor the protrusion 19 is provided, there is a possibility that the latch 40 is pushed up against the reaction force of the plate spring 41 and is detached from the circumference 17 of the opening portion when a strong force is applied to the cover 12. Such an event is likely to occur not only in the case where a man-caused force is exerted, but also for a reason of vibrations caused during traveling of a vehicle. According to the cover locking mechanism of the present embodiment, even when a strong force is exerted in the opening direction of the cover 12, the hook 46 is fitted to the protrusion 19, so that the latch 40 is prevented from being detached from the circumference 17 of the opening portion, thereby inhibiting any open of the cover beyond the length L4. That is, the second notch 47 has a configuration for preventing the cover 12 from being opened beyond an angle (a second open angle) larger than the first open angle.

To achieve immediate fitting of the hook 46 to the protrusion 19 when the circumference 17 of the opening portion is moved away from the first notch 44, it is desirable to have setting satisfying L3(L)<e+f. That is, a distance between the first notch 44 and the second notch 47 is set to satisfy such a relation that the protrusion 19 is fitted to the second notch 47 when the circumference 17 of the opening portion is detached from the first notch 44.

When a strong force is exerted in the opening direction of the cover 12 in the state shown in FIG. 6(d), the circumference 17 of the opening portion is first engaged with the first notch 44 as shown in FIG. 7(a) and then the protrusion 19 is fitted in the second notch 47 as shown in FIG. 7(b). That is, the first notch 44 mitigates shocks and accordingly deformation or damage of the hook 46 can be prevented.

For the protrusion 19 according to the present embodiment, a protruding portion obtained by processing a predetermined member 18 to have an substantially L-shape in cross section is used as shown in FIG. 5(b); however, as long as the protrusion 19 has a shape that can be fitted to the second notch 47, it is not limited to the member 18 as shown in FIG. 5(b).

With reference to FIG. 8, operations performed when the cover 12 is further opened from the state shown in FIG. 7(b) are explained. When the cover 12 is pressed toward the casing 10 so that the second notch 47 is moved away from the protrusion 19, the latch 40 slides into the inside of the casing 10. When the latch 40 slides into the inside of the casing 10, the first notch 44 is fitted to the circumference 17 of the opening portion as shown in FIG. 8. Next, the lower face of the latch 40 is pushed up. A portion to be pushed up is in a clearance between the cover 12 and the packing P. The hook 46 is detached from the circumference 17 of the opening portion, and therefore by pulling the cover 12 in the opening direction in this state, the cover 12 can be opened.

To prevent the protrusion 19 from being caught by the hook 46 when the latch 40 shown in FIG. 8 is pushed up, it is desirable to have setting to satisfy f<L3(L). That is, the distance between the first notch 44 and the second notch 47 is set to satisfy such a relation that the protrusion 19 is not fitted in the second notch 47 while the first notch 44 is fitted to the circumference 17 of the opening portion.

FIG. 9 is an illustration showing a latch not having the first notch. From the latch 40 shown in FIG. 9, the first notch 44 is omitted. For example, when one cover 12 has both the latch 40 shown in FIG. 5 and the latch 40 shown in FIG. 9, the cover 12 can be held fixedly at the position of the first notch 44 by the latch 40 shown in FIG. 5, thereby making it possible to reduce costs of the latch 40.

As described above, the cover locking mechanism according to the present embodiment has the plate spring 41 one end 41a of which is attached to the cover 12 and which provides a biasing force in a direction from the inner side of the cover 12 toward the circumference 17 of the opening portion onto the latch 40 thereby to bias the latch 40 attached to the other end 41b toward the circumference 17 of the opening portion and to bring the latch 40 into contact with the circumference 17 of the opening portion. The latch 40 has a configuration for keeping the cover 12 at the first open angle and also a configuration for preventing the cover 12 from being opened beyond the second open angle larger than the first open angle, during the opening operation of the cover 12. Therefore, even when the cover 12 is strongly pulled forward, the protrusion 19 is fitted in the second notch 47, thereby making it possible to prevent the hook 46 from being deformed or damaged.

### Second Embodiment

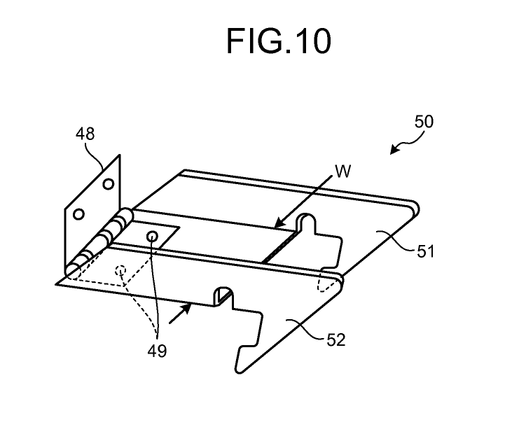

FIG. 10 is an illustration showing a cover locking mechanism according to a second embodiment of the present invention. The cover locking mechanism according to the second embodiment uses a spring hinge 48 instead of the plate spring 41 of the first embodiment. Furthermore, the cover locking mechanism according to the second embodiment uses a bent latch 50 having a U-shape in cross section instead of the latch 40 of the first embodiment.

Bent portions 51 and 52 have the same configuration as the latch 40 in the first embodiment. One ends of the bent portions 51 and 52 are arranged at the other end of the spring hinge 48 with fastening members 49 such as rivets. A width W of the bent latch 50 is slightly greater than that of the spring hinge 48.

When a structure not requiring welding is adopted in this way, any worker who can perform a fastening operation of a rivet or the like can fabricate the cover locking mechanism. Although the latch 40 in the first embodiment is hooked at only one position of the circumference 17 of the opening portion, the bent latch 50 according to the second embodiment has such a configuration that two latches 40 each corresponding to one of the first embodiment are installed therein. Therefore, when the bent latch 50 is applied, the cover locking mechanism that is more secure than the first embodiment can be realized.

### INDUSTRIAL APPLICABILITY

As described above, the present invention is applicable to a locking mechanism of a cover attached to a casing that accommodates electronic devices and the like, and is particularly useful as an invention that enables to suppress function deterioration and improve checking efficiency.

### REFERENCE SIGNS LIST

10 CASING
12 COVER
13 HANDLE
14 HINGE
15 STOP
16 PACKING GLAND
17 CIRCUMFERENCE OF OPENING PORTION
18 PREDETERMINED MEMBER
19 PROTRUSION
40 LATCH
40a ONE END OF LATCH
40b OTHER END OF LATCH
41 PLATE SPRING
41a ONE END OF PLATE SPRING
41b OTHER END OF PLATE SPRING
42 BACK CLEARANCE
43 WELDED PORTION
44 FIRST NOTCH
45 INCLINED PORTION
46 HOOK (HOOK FACE)
47 SECOND NOTCH
48 SPRING HINGE
49 FASTENING MEMBER
50 BENT LATCH
51, 52 BENT PORTION
P PACKING

1. A cover locking mechanism that is provided to a cover hinged to an opening portion of a casing to be openable/closable by a hinge and has a latch formed to be hookable on to a circumference of the opening portion of the casing, the cover locking mechanism comprising:
a plate spring, one end of which is attached to the cover, and which provides a biasing force in a direction from an inner side of the cover toward the circumference of the opening portion thereby to bias the latch attached to the other end of the spring toward the circumference of the opening portion and to bring the latch into contact with the circumference of the opening portion,
wherein the latch includes:
a first notch that is fitted to the circumference of the opening portion to hold the cover at the first open angle, and
a second notch that is fitted to a predetermined member provided on the circumference of the opening portion to prevent the cover from being opened beyond the second open angle.

2. (canceled)

3. The cover locking mechanism according to claim 1, wherein
the latch is formed into a hook,
the first notch is formed into a recess at a predetermined distance from one end of the latch, and
the second notch is formed into a recess on a hook face that is provided on a side closer to the casing than the first notch.

4. The cover locking mechanism according to claim 1, wherein where L denotes a length from the first notch to the hook face, e denotes a plate thickness of the casing, and f denotes a height of a protrusion that is provided on the casing and fitted in the second notch, L is set to a value satisfying a relation of L<e+f.

5. The cover locking mechanism according to claim 4, wherein f is set to a value satisfying a relation of f<L.

6. The cover locking mechanism according to claim 1, wherein the first notch and the second notch are provided in directions orthogonal to each other.

7. The cover locking mechanism according to claim 1, wherein the first notch and the second notch are provided in a member obtained by forming a plate material into a substantially U-shape in cross section.
